(19) United States
(12) Patent Application Publication
(10) Pub. No.: US 2012/0171655 A1
(43) Pub. Date: Jul. 5, 2012

(54) SYSTEM AND METHOD FOR MANAGING ACTION PLANS IN ELECTRONIC FORMAT FOR PARTICIPANTS IN AN INSTRUCTIONAL COURSE

(75) Inventors: Magnus NYLUND, Reston, VA (US); Jennifer Wilson, Sterling, VA (US); Brian Green, Alexandria, VA (US); Ernest W. Zahn, Redondo Beach, CA (US); Alexander E. Dagunts, Rockville, MD (US)

(73) Assignee: LEARNING TREE INTERNATIONAL, INC.

(21) Appl. No.: 13/343,596

(22) Filed: Jan. 4, 2012

Related U.S. Application Data
(60) Provisional application No. 61/430,067, filed on Jan. 5, 2011.

(51) Int. Cl. G09B 5/00

(52) U.S. Cl. 434/350

(57) ABSTRACT

In an instructional course, students learn various tools, techniques, and lessons that may be applicable to the students' projects. Based on the various tools, techniques, and lessons presented in the instructional course, each student develops one or more action plans after consulting the student's supervisor. The one or more action plans are entered into an action plan system that keeps track of progress and/or updates on the one or more action plans by the student. The action plan system sends out one or more electronic notifications to the students and their supervisors so that the students and/or supervisors can complete one or more surveys and enter updates on the one or more action plans. The entered updates on the one or more action plans can be used to generate various reports on the status of the one or more action plans.

### CROSS REFERENCE TO RELATED APPLICATION

This application claims benefit of co-pending U.S. Provisional Application No. 61/430,067, filed Jan. 5, 2011, the contents of which are incorporated herein in its entirety.

### BACKGROUND

Private companies and government agencies have a variety of training needs for then employees to improve work performance. For example, many companies send their employees to training courses for development of their skills in areas such as project/program management, acquisition management, business management, leadership and interpersonal skills, etc. Also, employees are encouraged to seek out and attend various work-related training courses and learn new tools, techniques, and lessons, or sharpen their existing skills. Many training courses are offered at training facilities in classroom settings for a couple of days or weeks. Also, many training courses are offered over the Internet to meet the needs of people who cannot attend in-class instructional training. Regardless of whether or not the students attend training courses in classroom or online settings, often written multiple choice tests are used to measure the level of knowledge acquired and retention of the knowledge acquired by the students. Sometimes surveys are provided to the students to evaluate the content and quality of the training during or after the training course ends. In some training courses, however, there is no written test or other means for measuring the effectiveness of the training course and students' learning. In some courses, students are encouraged to apply lessons, tools, and/or techniques that are presented in the training course to their current projects or work assignments to solve challenging problems. In such cases, the students often write down on a piece of paper some of the problems and try to come up with a solution based on the lessons, tools, and/or techniques learned during the training course, but after they return to work they often forget and fail to follow through because of their busy work schedule, other urgent matters, or lack of proper systematic support.

As a result, after completing the training or instructional course, the lessons, tools, and/or techniques learned during the course are often not used and applied at work to improve the performance of the projects or program in which the students are involved. Further, even for some motivated students, it is difficult to apply the lessons, tools, and/or techniques learned to their projects, because they have to document them at their discretion and follow through on their own.

Hence, there is still a need for an improved and/or simplified technique for ensuring that lessons, tools, and/or techniques learned in a training course are captured, implemented, and applied at the workplace, via a system to keep track of resulting improvements.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a high level diagram illustrating an exemplary system for implementing the disclosed techniques to ensure that lessons, tools, and/or techniques learned in an instructional course are applied for desired performance improvements at work.

FIG. 2 illustrates an exemplary overall process for the disclosed techniques at a high level.

FIG. 3A illustrates an exemplary graphical user interface for an action plan in the disclosed techniques.

FIG. 3B illustrates an exemplary graphical user interface for an implementation task for an action plan in the disclosed techniques.

FIGS. 4A-4C illustrate exemplary process flows for implementing the disclosed techniques.

FIG. 5 is a simplified functional block diagram of a computer that may be configured as a host or server, as shown in the system of FIG. 1.

FIG. 6 is a simplified functional block diagram of a personal computer or other work station or terminal device.

### DETAILED DESCRIPTION OF PREFERRED EMBODIMENTS

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

The techniques disclosed herein require development of one or more action plans following a training or instructional course so that a more meaningful relationship between classroom concepts and real-world practices is obtained. Through the techniques disclosed, participating students in the instructional course are required to identify specific practices, tools, techniques, and/or lessons learned that are applicable to their work. That is, the participating students will identify one of the documented best practices learned in the course and create a business case for implementing their idea back at work. As a result, the participating students are able to improve performance, reduce risk, solve a challenging workflow issue, or improve policies and procedures through the techniques disclosed.

An apparatus for managing action plans in electronic format over a network includes an interface for network communication, a processor coupled to the interface, programming for the processor, and storage for the programming. Execution of the programming by the processor causes the apparatus to perform various functions. For example, the apparatus receives registration data regarding one or more participants enrolled in an instructional course. The apparatus further receives information relating to one or more action plans for each participant, wherein the one or more action plans include one or more tasks to be implemented, based on practices and lessons presented in the instructional course. The apparatus further stores the received information relating to the one or more action plans and sends one or more electronic notifications over a network to participants for completing one or more surveys before, during, or after the instructional course. Responsive to the one or more electronic notifications, the apparatus further receives survey responses from the one or more participants before, during, or after the instruction course, and stores the received responses.

A method for managing action plans via a computer for one or more participants in an instructional course is provided. Registration data regarding the one or more participants enrolled in the instructional course is received. Information relating to one or more action plans for each participant is also received. The one or more action plans include one or more tasks to be implemented, based on practices and lessons presented in the instructional course. The received information relating to the one or more action plans is stored. Also, before, during, or after the instruction course ends, electronic notifications are sent over a network to the participants. Responsive to the electronic notifications, survey responses from the participants are received. The one or more actions plans are updated.

Further, a system including an action plan system and a terminal device is provided for the techniques disclosed. The action plan system is configured to manage action plans for one or more participants enrolled in an instructional course. The terminal device is configured to communicate with the action plan system via a network. The participants have access to the terminal device. The action plan system performs various functions. For example, the action plan system receives registration data regarding the one or more participants in the instructional course before start of the instructional course. The action plan system further receives information relating to one or more action plans for each participant via the terminal device over the network, wherein the one or more action plans include one or more tasks to be implemented, based on practices and lessons presented in the instructional course. The action plan system further stores the received information relating to the one or more action plans. The action plan system further sends one or more electronic notifications over the network to the one or more participants for completing one or more surveys before, during, or after the instruction course. Responsive to the one or more electronic notifications, the action plan system further receives survey responses from the one or more participants before, during, or after the instruction course and stores the received survey responses.

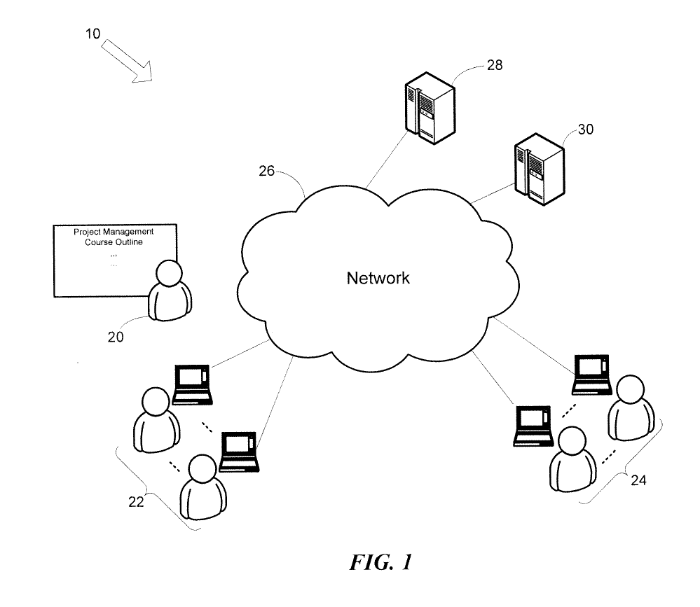

Reference now is made in detail to the examples illustrated in the accompanying drawings and discussed below. FIG. 1 illustrates a high level diagram illustrating an exemplary system for implementing the techniques disclosed to ensure that lessons, tools, and/or techniques learned in an instructional course are implemented for desired performance improvements at work by students.

The exemplary system 10 includes a course instructor 20, one or more students 22 in an instructional course, one or more supervisors 24, a network 26, a student registration system (SRS) 28, and an action plan system (APS) 30. In FIG. 1, it is presumed that training in a particular subject matter is provided to a group of students 22 in a classroom setting. Alternatively, the training can be provided online to the group of students 22 over the network 26. In the example, subject matter of the training can be project/program management, business management, leadership skills, etc., or any other training that will provide the students with tools and techniques that can be applied to challenges at their workplace. While a traditional method of evaluating and measuring students' knowledge retention is administration of standard multiple choice tests, the disclosed techniques use “action plans” to measure the students' acumen and accountability through implementation of the action plans. The term “action plan” herein describes one or more electronically documented specific tasks or steps that each student will take in applying one or more newly acquired skills, tools, and/or techniques from an instructional course. The one or more action plans are created by participating students 22 working together with their supervisors 24 during and/or after the instructional course to mitigate a risk currently facing their project or program.

In the example, the network 26 is one or more communication networks including a local area network, a wireless network, a wide area network, such as the Internet and other private networks, or any of a number of different types of networks. Connected to the network 26 are the student registration system 28 and action plan system 30. The student registration system 28 is one or more servers including at least one database containing registration data of students. The registration data can include, among other information, course title, student name, student e-mail, supervisor name, supervisor e-mail, etc. The student registration system 28 also provides a web-based interface for student registration and management of the registration data for various purposes including tracking training programs. In the example, the student registration system 28 sends the registration data to the action plan system 30 via a secure file transport protocol (FTP).

The action plan system 30 is one or more servers implementing the techniques disclosed herein and includes at least one storage for action plan related data, such as action plans, progress updates, survey responses, action plan comments, etc. For example, the action plan system 30 can be implemented on a web server and SQL server. The action plan system 30 provides various user interfaces including web-based interfaces for receiving data relating to action plans by students, updating implementation tasks, receiving survey responses, generating action plan status reports, downloading data, etc. Alternatively, a remote database can store various action plan related data, such as action plans, survey responses, etc., and provide the action plan related data to the action plan system via a network when queried by the action plan system 30. Each participating student 22 has access to update his or her action plans starting on the first day of the instructional course through the tenth business day after the course ends. At the end of the tenth business day after the course ends, the action plan system 30 locks students' access to update the action plans. That is, the participating students 22 cannot update their action plans without approval from a designated administrative person of the action plan system 30. However, the participating students 22 can view their action plans at any time via online access. Further, the action plan system 30 provides access for supervisors of the participating students 22 to access and view the action plans for their employees. The action plan system 30 also provides access to the designated administrative person (via login and password) to download data relating to action plans, implementation tasks and survey responses, etc. The administrative person will be able to both unlock the action plan and also download all report data.

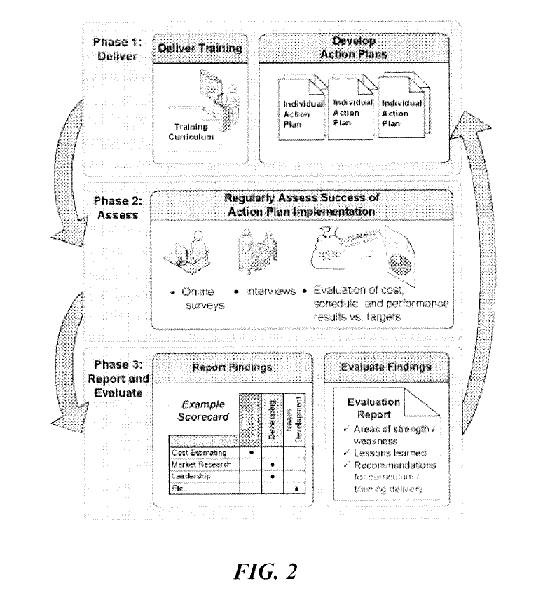

FIG. 2 illustrates an exemplary overall process for tracking performance improvements using action plans disclosed herein, at a high level. In the example, at phase 1, students receive training in various subject matters, such as project/program management, business management, leadership skills, etc., in a classroom setting. During and after the course, each student will develop and document specific steps, as part of action plans, that they will take to apply a newly acquired skill from their instructional course that directly mitigates a risk currently facing the student's project or program. The action plans provide students with a direct correlation between the competencies acquired in the classroom and the specific risks associated with their projects that they are expected to mitigate.

In the example, action plan development is supported by course instructors during class time, along with discussion and guidance to support implementation of the action plan. To provide continued support after the conclusion of the course, data relating to action plans are available online via an action plan system to students; and the course instructions are available to answer student questions and provide personalized advice or support during action plan implementation. Further, issues encountered by students during the action plan implementation will be captured by survey and interview responses.

At phase 2, successful implementation of action plans is regularly monitored and assessed using various methods. In the example, surveys and interviews are utilized. For example, to assess successful retention and application of competencies, tools, and/or techniques presented in an instructional course, online surveys are made available for recent student participants, project/program supervisors, and/or other stakeholders. The online surveys will gauge the extent to which action plans are being implemented and opinions on how lessons, tools and techniques learned (e.g., project/program management techniques) have improved since the training. Student participants will complete surveys anonymously to encourage open, honest feedback about challenges facing them. Also, when surveys are completed, the student participants will be reminded to update the action plans. Alternatively, interviews can be used and supplemented. The student participants and their supervisors are interviewed about the use of specific behaviors, tools, and techniques in specific scenarios, and their impact. Candid and independent interviews on the progress the student participants are making provide input into evaluating and assessing the success of the project and ways that the newly acquired knowledge and skills can be applied. Further, based on the survey responses and updates to the action plans, progress on the action plans are tracked and monitored. In tracking and monitoring the progress, various tools can be utilized, for example, a performance management accountability system (PMAS), dashboard, or the like to provide the sources of metrics for measuring the progress of the programs and projects. As a result, using the measures and other metrics (e.g., associated cost, schedule, and performance metrics), an analysis can be made as to the progress of the programs and projects employing students using the action plan system, which provide objective and quantifiable data on how these newly acquired knowledge and skills are impacting project delivery at the workplace.

At phase 3, using various tools and techniques (e.g., score cards, dashboard, improvements charts, or the like), results or monthly data from the action plan system are gathered, analyzed, and reported to other stakeholders including management. For example, in reporting the results, techniques such as scorecards, dashboards, and other report forms are used to effectively communicate impact and progress over time of the action plans and associated projects/programs to management. Also, monthly reports and evaluation of findings via the action plan system can expose various issues, identify root causes, and recommend potential solutions and curriculum modifications for instructional courses.

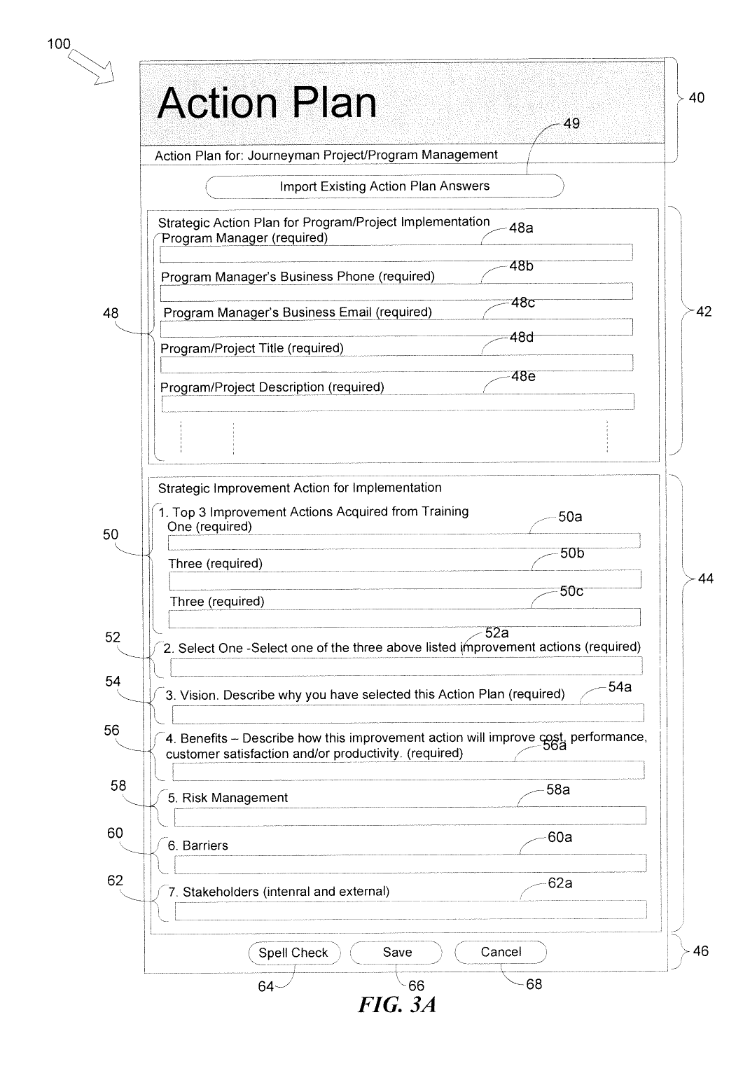

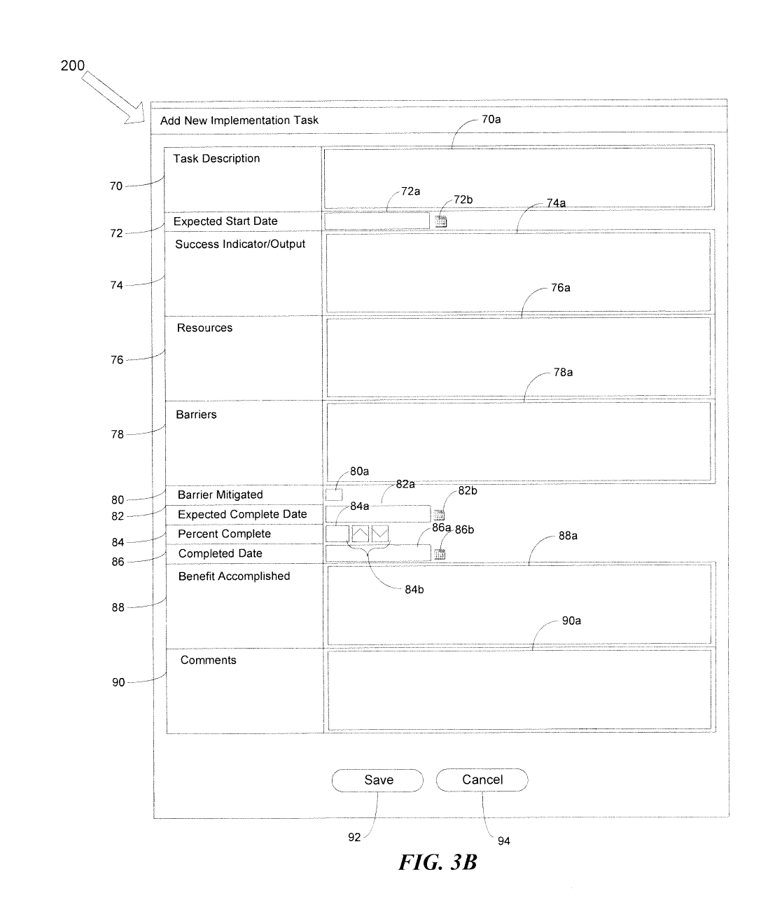

FIGS. 3A and 3B illustrate exemplary graphical user interfaces for action plan system 30 in FIG. 1.

FIG. 3A illustrates an exemplary graphical user interface (GUI) for a user to enter an action plan into the action plan system 30. For example, the GUI 100 shows a simplified graphical user interface for an action plan for a student who is enrolled in a project/program management course (e.g., an action plan for “Journeyman Project/Program Management”). The GUI 100 includes a plurality of areas 40, 42, 44, and 46. The area 40 provides general information that the current action plan is for a journey level project/program management course. The area 42 is a user input area for strategic action plan for program/project implementation. The area 44 is a user input area for improvement action for implementation.

The area 42 includes a plurality of user input fields 48 and associated text boxes 48a-48e. Using the user input fields 48 a student enters various (required) information related to the student's current project or program within which the student is planning to implement one or more action plans. For example, the student can enter into the action plan system 30 by entering descriptions of various project/program related information into the associated text boxes 48a-48e, such as program manager's name, e-mail, and phone number, program/project title, and program/project description, etc. As shown, although all the user input fields 48 are required fields, some user input fields 48 can be optional.

In the example, the area 44 of the GUI 100 is provided such that the student can describe one or more project related action plans and select one action plan for implementation after the course ends. The area 44 includes a plurality of text fields, such as “Top 3 Improvement Actions” 50, “Select One” 52, “Vision” 54, “Benefits” 56, “Risk Management” 58, “Barriers” 60, and “Stakeholders” 62, and respective text boxes 50a-62a. In “Top 3 Improvement Actions” field 50, the student describes, in the text box 50a, top 3 improvement actions acquired from training by the student. For example, the student is required to list in the text boxes 50a-50c, the top 3 strategic improvement actions that will improve the student's project performance at work, leading to a more consistent, department-wide management capability. After describing the top 3 strategic improvement actions, in “Select One” field 52, the student is required to select one of the three above listed improvement actions, and further describe the selected one improvement action, in the text box 52a, as the student's personal commitment to implement the action plan. In “Vision” field 54, the student is required to describe, in the text box 54a, why the student has selected the one action plan as the personal commitment in “Select One” field 52. Here, some expected results from implementing the selected action plan can be described, for example, to improve data-driven decisions, reduce costs, create productivity improvements, increase stakeholder awareness, etc. In “Benefit” field 56, the student is required to describe, in the text box 56a, how the improvement action will improve cost, performance, customer satisfaction and/or productivity. The student can identify qualitative and/or quantitative analysis of benefits to key stakeholders and other customers. In “Risk Management” field 58, the student is required to identify ongoing exposure to the student's organization if the improvement action is not implemented. The ongoing exposure can be described in terms of cost, performance, productivity, security, safety, etc. In “Barriers” field 60, the student is required to identify and describe, in the text box 60a, major barriers the student expects to overcome in order to successfully implement the improvement action. The barriers can be obstacles within the student's control and those outside of the student's control that will require the student's influence and collaboration. Also, the student is required to define and describe how the student will mitigate these identified barriers. In “Stakeholders” field 62, the student is required to list, in the text box 62a, all stakeholders, both internal and external, that must buy into the improvement action and set forth a plan to gain their agreement. Also, for the stakeholders, the student can consider other program managers within the organization that could benefit from the improvement action and develop a coalition.

In the GUI 100, a plurality of user selectable buttons 64, 66, and 68 are included in the area 46. By selecting the “Spell Check” button 64, the student can perform a spell check on the texts entered in the GUI 100. Also, by selecting the “Save” button 66, the student can save the information entered and submit the action plan to the action plan system 30. By selecting the “Cancel” button 68, the student can cancel submitting the action plan and start it over.

After entering the description of one or more action plans, as illustrated above in FIG. 3A, the student is prompted to enter one or more implementation tasks in detail for the action plan entered.

FIG. 3B illustrates an exemplary graphical user interface 200 for entering the one or more implementation tasks for the action plan entered into the action plan system 30. The GUI 200 includes a plurality of information fields 70-90 (e.g., “Task Description” 70, “Expected Start Date” 72, “Success Indicator/Output” 74, “Resources” 76, “Barriers” 78, “Barrier Mitigated” 80, “Expected Complete Date” 82, “Percent Complete” 84, “Completed Date” 86, “Benefit Accomplished” 88, “Comments” 90 and associated fields (e.g., text and selection fields). The “Task Description” field 70 is provided so that the student can describe a specific implementation task to perform in an associated text box 70a. The “Expected Start Date” field 72 includes associated date selection field 72a and calendar icon 72b. In the date selection field 72a, the student can enter the start date for performing the implementation task. Alternatively, the student can click a calendar icon 72b and select the start date on the calendar displayed.

For the “Success Indicator/Output” field 74, the student describes in the text box 74a expected output to be obtained by performing the implementation task. For the “Resources” field 76, the student describes in the text box 76a resources to be used in carrying out the implementation task. For the “Barriers” field 78, one or more barriers expected in carrying out the implementation task by the student are to be described in the text box 78a. The “Barriers Mitigated” field 80 indicates whether the barriers are mitigated. If the barriers are mitigated, then the student checks the indicator box 80a. The “Expected Complete Date” field 82 is for indicating the expected date of completion of the implementation task. The student can enter the expected completion date for the implementation task in the date field 82a. Alternatively, the student can click a calendar icon 82b and select the expected completion date on a calendar displayed.

The “Percent Complete” field 84 indicates progress on the implementation task in terms of percentage (e.g., 0-100%). The student can indicate an approximate percentage completion of the implementation task by entering a numerical value (e.g., a number between 0 and 100) into a box 84a or use the up and down buttons 84b to select a numerical value. The “Completed Date” field 86 indicates an actual completion date of the implementation task. After completing the implementation task, the student can enter the completion date into the action plan system by using the date entry box 86a or calendar icon 86b. In the “Benefit Accomplished” field 88, the student can describe the actual benefits obtained through completion of the implementation task in the text box 88a. Further, for any additional comments regarding the student project, implementation tasks, etc., the student can enter additional comments in the text box 90a of the “Comments” field 90. Also, the GUI 200 provides a plurality of user selectable buttons 92 and 94. The “Save” button 92 allows the student to save all the entries in the GUI 200 into the action plan system. Alternatively, the “Cancel” button 94 permits the student to cancel all the current entries.

In the example, some fields, such as the “Task Description” field 70, “Expected Start Date” field 72, “Success Indicator/Output” field 74, “Resources” field 76, “Barriers” field 78, can be “locked down” (e.g., changes to the fields are not allowed by students without authorization from administrative personnel for any change) after the 10-day action plan editing period (“lock down” period). Except those locked down fields, other fields are updatable either by a student or student's supervisor even after the 10-day action plan editing period. It is noted that the word “editable” or “updatable” is used herein to mean that a field can be modified by the student or student's supervisor after the lock down period.

Each action plan includes one or more implementation action plans broken down into one or more implementation tasks that a participating student defines. Tasks have some fields that are locked down (e.g., students cannot edit the fields after a certain period of time) and some fields that are updatable. Each update is saved as a separate record so that progress can be tracked in the action plan system 30. Additional tasks can be defined and entered at any time by the student. Also, the implementation tasks are expected to be updated at minimum on a monthly basis by the participating student during a survey. When a survey is submitted, the action plan system prompts the participating student to update the implementation tasks.

After the completion of an instructional course, participating students complete one or more surveys to show progress on the action plans the second Monday of each month. The students are notified via email that the action plan system 30 has a survey available for them to complete. The action plan system 30 keeps a record of a survey completion status to send out survey emails. For example, the action plan system 30 contains a Yes/No flag to continue to trigger sending survey emails to the students, and when the action plan system 30 determines if the flag is set to yes, monthly survey emails are automatically sent to the students. Further, the students can view their own survey submissions at all times, but their survey responses are not viewable to their supervisors. In the example, participants submit a survey only once per survey period and the survey is expected to be completed in one session. Once submitted, however, the survey is locked and survey responses cannot be changed after submission. Also, one or more surveys are sent to the students' supervisors to solicit feedback relating to the participating student's performance in connection with the action plans.

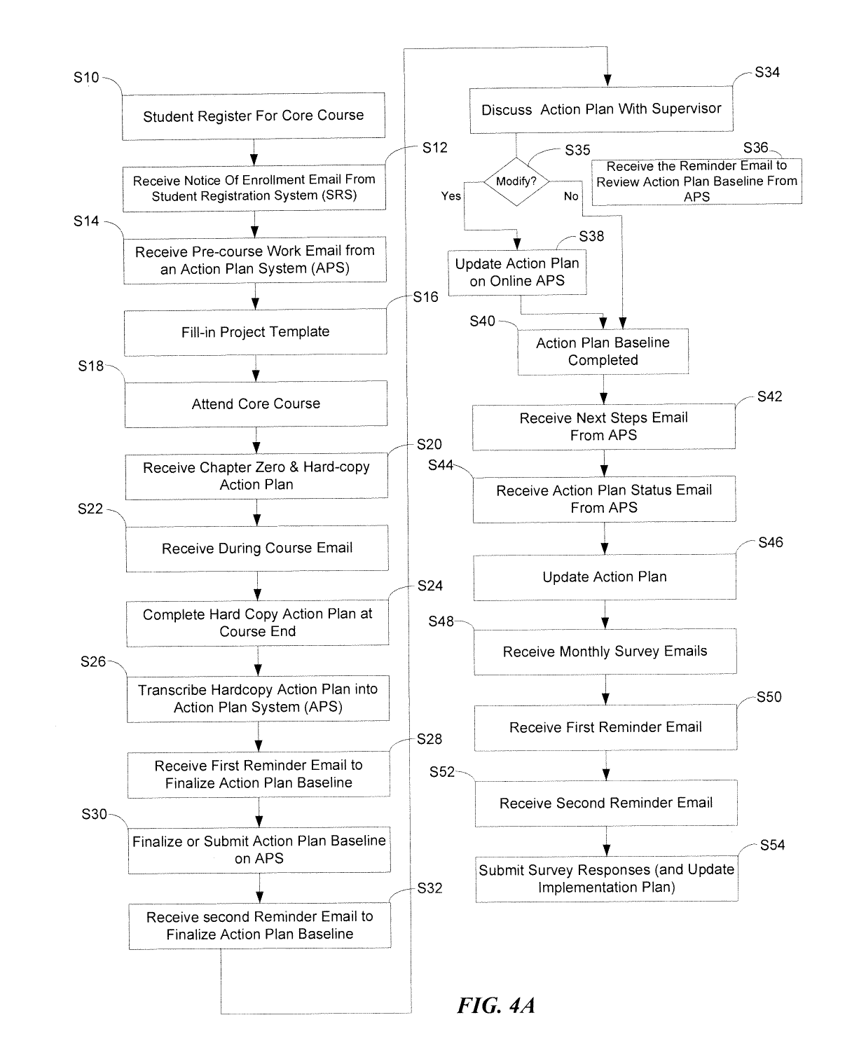

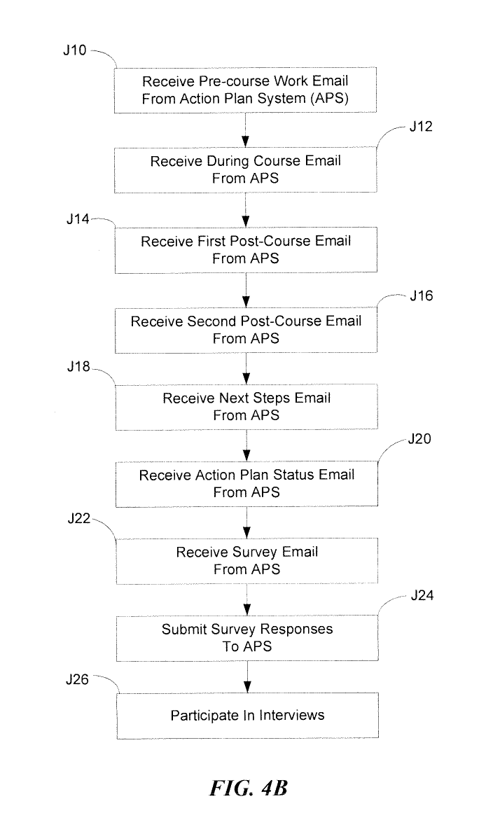

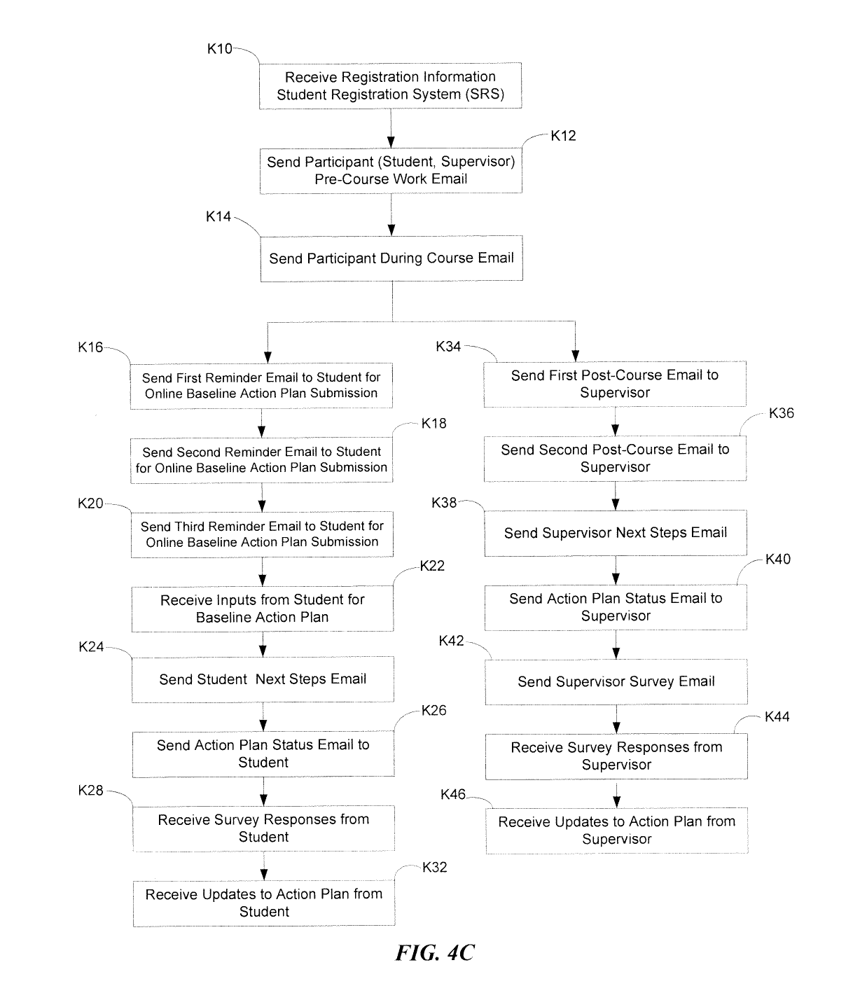

FIGS. 4A-4C illustrate exemplary process flows in details for implementing the disclosed techniques herein.

FIG. 4A illustrates an exemplary flow from the perspective of a student participant in an instructional course. At S10, a student 22 enrolls for an instructional course via a student registration system (SRS) 28. The registration may remain “pending approval” until approved by the student's employer. At S12, the student 22 receives a notice of enrollment email from SRS 28. After registration, the student 22 receives, at S14, a pre-course work email from an action plan system (APS) 30, which will be described in detail below. The student 22 receives the pre-course work email two weeks before start of the instructional course. The pre-course work email includes, for example, information about action plan roles, expectations, project template, etc. Upon receiving the pre-course work email, the student 22 is to review expectations and complete pre-work with the student's supervisor 24.

At S16, the student 22 fills in a project template after meeting with the student's supervisor 24 to select project document, project data and identify project challenges that are expected. The project template includes various project information and expected project challenges.

At S18-S20, the student 22 attends the instructional course and receives course materials. The student 22 receives a hard-copy action plan (e.g., hard copies of action plan forms) and chapter zero information from an instructor 20. The chapter zero information includes presentation of background, role of action plans during and after class, and other information relating to the action plans.

At S22, the student 22 also receives emails relating to the action plans during the instructional course. For example, enrolled students 22 receive email with attachments including an action plan user guide, on day two of the instructional course or the last day of the first course segment of a boot camp. The students 22 are provided with instructions on how to enter action plans into the action plan system 30, and upon receiving the email, the students can begin entering data in APS 30 via a network 26.

At S24, the student 22 completes the hard copy action plan and the instructor 20 signs off on an action plan for the instructional course. At S26, the student 22 can transcribe or enter descriptions of one or more action plans into the action plan system 30 via the network 26 at a client terminal. Also, the student 22 can print out the student's action plans and have the instructor 20 sign off on the print-out.

In the example, after completion of the course, the student 22 finalizes one or more action plans as baseline action plans, as shown in S28-S42. At S28, the student 22 receives a first email reminder to finalize one or more baseline action plans for the student 22. The first email reminder to finalize the one or more baseline action plans is sent out to the student 22 the next business day after the instructional course is completed. The “baseline” action plan is described herein to mean an action plan that the student 22 in consultation with student's supervisor 24 has decided to implement at work after the completion of the training. At S30, the student 22 finalizes and submits the student's baseline action plans to the action plan system 30. The student 22 can add, modify, or complete as appropriate, baseline action plans online on the action plan system 30 on the network 26. At S32, the student 22 receives a second reminder email to submit one or more baseline action plans after the fifth business day after the completion of the instructional course. At S34, the student 22 meets with the student's supervisor 24 to discuss the one or more baseline action plans for possible revision. The student 22 and supervisor 24 have another five business days to review the action plans before the action plan system 30 automatically “locks out” ten business days after the course end date. That is, after ten business days upon completion of the instructional course, the action plan system 30 does not allow any modifications to the action plans by the student 22 and supervisor 24, and all fields are not updatable or non-editable. To modify the action plans, the student 22 or supervisor 24 needs to contact the operator of the action plan system 30 for authorization. Within the ten day period, however, if any modification is needed, at S35, the student 22 can update the action plans stored in the action plan system 30 via online, at S38, and save them as baseline action plans, at S40. On the other hand, if modification is not needed, the previously entered action plans are saved in the action plan system 30 as baseline action plans for the student 22 and supervisor 24, at S40. At S42, the student 22 receives a next steps email from the action plan system 30 regarding what to expect in the future in connection with the action plans. That is, the next steps email is received within ten business days after completion of the instructional course and includes information relating to action plan status, monthly surveys, monthly updates, and the like. At S44, the student 22 receives an email including a status of action plans, such as either “no submission status,” “incomplete status,” or “complete status.”

In the example, the student 22 has access to the action plans 24 hours a day, 7 days a week (24/7) on the action plan system 30 via a network 26. The student 22 is encouraged to update at minimum once a month, at S46. At 48, the student 22 receives monthly survey emails from the action plan system 30. The survey emails are sent starting the second Monday of every month to be completed in ten calendar days. A survey email informs the student 22 that a survey is ready in the action plan system 30. The student 22 logs into the action plan system 30 and clicks a survey link to respond to the survey. After the survey response is saved, a reminder message pops up asking the student 22 to update the implementation tasks for the student's action plan(s).

The action plan system 30 keeps track of a status of each survey for the student 22. The action plan system 30 determines whether or not the survey is submitted for each participating student 22 and sends out survey reminders via emails to those who have not submitted. Also, if a survey is not completed within a survey period, the survey can expire. That is, the survey is not available for submission after the survey period, and there is no additional remediation for a skipped survey. However, within the survey period (e.g., before it expires), the student 22 receives one or more reminder emails of non-compliance, including directions on how to remediate.

In addition, the action plan system 30 internally marks the status of one or more action plans for each student 22 as “complete submission,” “incomplete submission,” or “no submission.” An action plan for the student 22 is internally marked as “no submission” when there is no data entered in the baseline action plan on the day after the lockout date. An action plan for the student 22 is internally marked as “incomplete submission” when there are some action plan related data but not enough (e.g., the student 22 has not completed his or her baseline action plan). When the action plan has a status of “incomplete submission,” the action plan remains in a pending status until it is reviewed by someone (for example, an administrator of the action plan system 30) who has authority to review and change the status of the baseline action plan.

At S50 and S52, the student 22 receives reminder emails for completing one or more surveys and updating the student's action plans online. A first reminder email for completing the one or more surveys is sent, for example, three days after the second Monday of the month; and a second reminder email is sent five days after the second Monday of the month.

At S54, the student 22 submits survey responses and updates the student's action plans (e.g., updates implementation plan tasks) on the action plan system 30 via the network 26.

FIG. 4B illustrates an exemplary process flow for students' supervisors 24. In the example of FIG. 4B, at J10, a supervisor 24 of a student 22 who enrolled in an instructional course receives a pre-course work email. The supervisor 24 receives the pre-course work email two weeks before start of the instructional course, including information relating to the student or staff 22 enrolled, the role of action plans, and expectations. After receiving the pre-course work email, the supervisor 24 meets with the student 22 to discuss expectations and complete pre-work before the start of the instructional course. At J12, the supervisor 24 receives during course emails from the action plan system 30. The during course emails include a reminder of course content covered in the instructional course, and a reminder to support action plan preparation and go over action plans with the student 22 or staff members after the instructional course ends. After the instructional course, at J14 and J16, the supervisor 24 receives one or more post-course emails. The post-course emails include emails including instructions to access the action plan system 30 and a reminder of the supervisor's role. At J18, the supervisor 24 receives an email indicating next steps and responsibilities for staff and including a reminder of the role of supervisor 24 in implementing action plans. After the completion of the instructional course, at J20, the supervisor 24 receives one or more action plan status emails for each student 22 who has completed the instructional course. The action plan status emails include various information, such as status of the action plans, including either of “no submission,” “incomplete,” or “complete,” and associated remedial instructions. Further, at J22, the supervisor 24 regularly receives survey emails from the action plan system 30. For example, the supervisor 24 receives the survey emails on a quarterly basis regarding the status of the action plans and implementation tasks progress updates. At J24, in response to the survey emails from the action plan system 30, the supervisor 24 submits, via the network 26, survey responses to the action plan system 30, updating the action plans, as needed. Further, at J26, the supervisor 24 participates in a follow-up interview.

FIG. 4C illustrates an exemplary process for implementing the techniques disclosed herein on an action plan system 30 via a network 26. Before an instructional course, the action plan system 30 receives, at K10, registration data relating to one or more students 22 enrolled in the instructional course, from a student registration system (SRS) 28. For example, on a daily basis the student registration system 28 provides daily registration data to the action plan system 30 providing participating students 22 and supervisors 24 account and enrollment information. At K12, the action plan system 30 sends out pre-course work emails to the participants (e.g., students and their supervisors), including information relating to action plan roles, expectations, project templates, etc. In the example, the pre-course work emails are sent two weeks before start of the instructional course to supervisors 24 who are listed in the SRS for all enrolled participating students 22. During the instructional course, the action plan system 30 sends, at K14, all participants one or more during course emails including information relating to action plans for the participants. In the example, the during course emails are sent on day 2 of the instructional course to all enrolled participants. The action plan system 30 is available for use by the participants (students 22 and supervisors 24) starting on the first day of the course.

After the end of the instructional course, at K16, the action plan system 30 sends a first reminder email for online baseline action plan submission to the students 22. The first reminder email for the baseline action plan submission is sent out the first business day after the completion of the instructional course to all enrolled or completed students 22 of the instructional course. At K18, a second reminder email for the baseline action plan submission is sent the fifth business day after the course completion date. At K20, a third reminder email for online baseline action plan submission is sent out the sixth business day after the course completion. At K22, the action plan system 30 receives inputs for the baseline action plans from participating students 22 and supervisors 24. Here, although it is shown that the action plan system 30 receives the inputs for the baseline action plans after K20, the action plan system 30 can receive the inputs from participating students 22 and supervisors 24 for the baseline action plans anytime after the first day of the course attendance. In one implementation, pre-course surveys are sent to the participating students 22 and supervisors 24, and the action plan system 30 displays and accepts pre-course survey responses for a course two weeks before the course starts.

At K24, the action plan system 30 sends the participating students 22 next steps emails. The next steps emails are sent to all participating students 22 who have the status “completed” in SRS for the instructional course and are sent on the first business day after the ten day baseline action plan submission period ends. At K26, the action plan system 30 sends action plan status emails to all participating students 22, including the status of an action plan, such as “no submission,” “incomplete submission,” or “complete submission.” The action plan status email containing “no submission” is sent to those who do not have entries in the action plan on the action plan system 30. The action plan status email containing “incomplete submission” is sent to those whose action plans are incomplete on the action plan system 30. The action plan status email containing “complete submission” is sent to those whose action plans are complete on the action plan system 30. At K28, the action plan system 30 periodically sends the participating students 22 one or more survey emails. A survey email includes a link to a survey and instructions on how to complete the survey. Also, the survey email can include instructions on how to access the action plans in the action plan system 30. After completing the survey, each participating student 22 is prompted (e.g., via a pop-up or reminder message, or the like) to update his or her implementation tasks or plans in the action plan system 30. Alternatively, the survey email can include a link to latest implementation tasks for updates. In the example, the participating students 22 are reminded to update the implementation tasks when the survey email is sent and again when the survey responses are submitted to the action plan system 30. Further, the one or more survey emails are sent in four week intervals from the completion of the instructional course. At K32, in response to the one or more survey emails, the action plan system 30 receives survey responses from the participating students 22 and updates to the action plans (e.g., updates to the implementation tasks).

In addition to sending reminder emails and survey emails to the participating students 22, the action plan system 30 also sends reminder emails and survey emails to supervisors 24 of the participating students 22, as in K34-K46. In the example, at K34, the action plan system 30 sends first post-course emails to students' supervisors 24. The first post-course emails are sent to the supervisors 24 the first business day after the instructional course ends. At K36, the action plan system 30 sends second post-course emails to the supervisors 24 the sixth business day after the instructional course ends. At K38, on the first business day after the ten day baseline action plan submission period ends, the action plan system 30 sends the supervisors 24 next steps emails. The next steps emails are sent to the supervisors 24 who have staff (e.g., students 22) with the status of “enrolled” or “completed” for the instructional course. As with the students 22, at K40, the action plan system 30 sends action plan status emails to the supervisors 24 informing them of action plan status. For example, the supervisors 24 are communicated with status of action plans, such as “no submission.” “incomplete submission,” or “complete submission.” An action plan status email including “no submission” is sent on the eleventh day after the end of the instructional course to supervisors and students who have no entries in their action plans in the action plan system 30. An action plan status email including “incomplete submission” is sent to supervisors 24 and students 22 whose action plans are not submitted as complete on the action plan system 30. An action plan status email including “complete submission” is sent to supervisors 24 and students 22 whose action plans are submitted as complete on the action plan system 30. At K42, the action plan system 30 sends to the supervisors 24 of the participating students 22 survey emails on a regular basis. For example, the survey emails are sent to the supervisors 24 quarterly one week after the participating student survey and before/during/after the instructional course. The survey emails include a link to a survey. Alternatively, a survey email can include a link to latest implementation tasks for updates. In the example, the participating students 22 are reminded to update the implementation tasks when the survey email is sent and again when the survey responses are submitted to the action plan system 30. At K44, the action plan system 30 receives survey responses from the supervisors 24 and stores them in a data storage of the action plan system 30 along with other information, such as action plans, progress updates, or the like. Alternatively, the action plan system 30 can store the received survey responses in a remote database containing action plans, progress updates, survey responses, action plan comments, or the like. At K46, the action plan system 30 receives updates to the action plans (e.g., updates to the implementation tasks) from the supervisors 24.

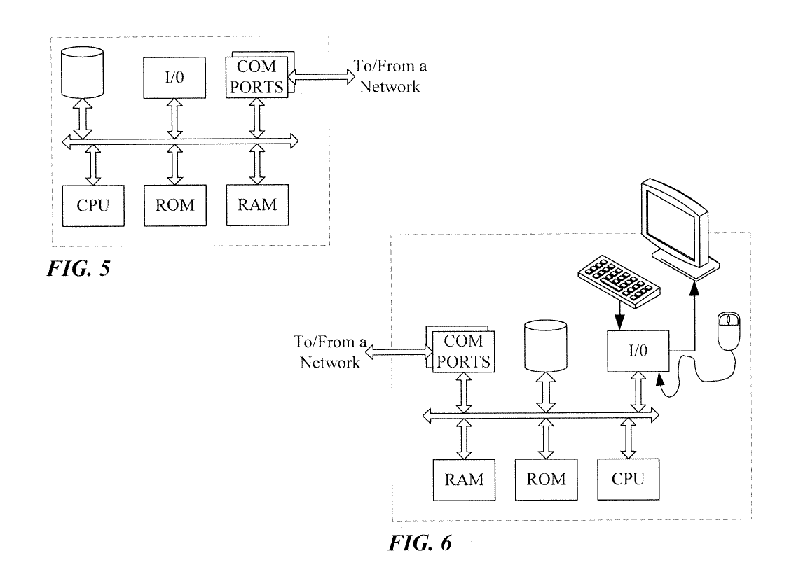

FIGS. 5 and 6 provide functional block diagram illustrations of general purpose computer hardware platforms. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is appreciated that the structure, programming and general operation of such computer equipment are familiar concepts and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of keeping track of performance improvements based on action plans in electronic form outlined above may be embodied in programming. Program aspects of the technology may be thought of as “products” or “articles of manufacture” typically in the form of executable code and/or associated data that is carried on or embodied in a type of machine readable medium. Storage type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the training provider into the computer platform of a customer company that will be the action plan system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the action plan system, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

In the preceding specification, various preferred embodiments have been described with reference to the accompanying drawings. It will, however, be evident that various modifications and changes may be made thereto, and additional embodiments may be implemented, without departing from the broader scope of the claims set forth below. The specification and drawings are accordingly to be regarded in an illustrative rather than restrictive sense.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. An apparatus for managing action plans in electronic format over a network, the apparatus comprising:
an interface for network communication;
a processor coupled to the interface:
programming for the processor; and
storage for the programming,
wherein execution of the programming by the processor causes the apparatus to perform the functions of:
receiving registration data regarding one or more participants enrolled in an instructional course;
receiving information relating to one or more action plans for each participant, wherein the one or more action plans include one or more tasks to be implemented, based on practices and lessons presented in the instructional course;
storing the received information relating to the one or more action plans;
sending one or more electronic notifications over a network to the one or more participants for completing one or more surveys before, during, or after the instructional course;
responsive to the one or more electronic notifications, receiving survey responses from the one or more participants before, during, or after the instructional course; and
storing the received survey responses.

2. The apparatus of claim 1, wherein the one or more participants include at least one student enrolled in the instructional course or a supervisor of the student.

3. The apparatus of claim 1, wherein receiving information relating to the one or more action plans for each participant includes:
storing the received information relating to the one or more action plans as baseline action plans, wherein the one or more action plans comprise implementation tasks for monitoring progress made on the one or more action plans by each participant;
receiving updates to the implementation tasks from the one or more participants; and
updating the one or more action plans with the received updates.

4. The apparatus of claim 3, wherein the execution of the programming by the processor further causes the apparatus to perform the function of processing the one or more updated action plans for each participant to generate one or more reports on the status of the one or more action plans.

5. The apparatus of claim 1, wherein the one or more electronic notifications are e-mails or mobile text messages over a network.

6. The apparatus of claim 1, wherein the one or more electronic notifications are periodically sent to each participant for completing the one or more surveys.

7. The apparatus of claim 6, wherein the one or more electronic notifications include at least one of a link to the one or more surveys or a link to the one or more action plans for updates.

8. The apparatus of claim 3, wherein each implementation task of the one or more action plans comprises a locked-down field and an updatable field.

9. A system comprising:
an action plan system configured to manage action plans for one or more participants enrolled in an instructional course; and
a terminal device configured to communicate with the action plan system via a network,
wherein:
the one or more participants have access to the terminal device; and
execution of programming by a processor of the action plan system causes the action plan system to perform the functions of:
receiving registration data regarding the one or more participants in the instructional course before start of the instructional course;
receiving information relating to one or more action plans for each participant via the terminal device over the network, wherein the one or more action plans include one or more tasks to be implemented, based on practices and lessons presented in the instructional course;
storing the received information relating to the one or more action plans;
sending one or more electronic notifications over the network to the one or more participants for completing one or more surveys before, during, or after the instructional course;
responsive to the one or more electronic notifications, receiving survey responses from the one or more participants before, during, or after the instructional course; and
storing the received survey responses.

10. The system of claim 9, wherein the function of receiving information relating to the one or more action plans for each participant includes:
receiving information relating to one or more action plans for each participant via the terminal device over the network;
storing the received information as baseline action plans for monitoring progress made by each participant, wherein the one or more action plans comprise implementation tasks for monitoring progress made on the one or more action plans by each participant;
receiving updates to the implementation tasks from the one or more participants; and
updating the one or more action plans with the received updates.

11. The system of claim 9, wherein the one or more participants include at least one student enrolled in the instructional coarse or a supervisor of the student enrolled.

12. The system of claim 9, wherein the execution of the programming by the processor further causes the action plan system to perform the function of processing the one or more updated action plans to generate one or more reports on the status of the one or more action plans.

13. The system of claim 9, wherein the one or more electronic notifications are e-mails or mobile text messages.

14. The system of claim 9, wherein the one or more electronic notifications are periodically sent to each participant for completing the one or more surveys.

15. The system of claim 14, wherein the one or more electronic notifications include at least one of a link to the one or more surveys or a link to the one or more action plans for updates.

16. The system of claim 10, wherein each implementation task of the one or more action plans comprises a locked-down field and an updatable field.

17. A method for managing action plans, via a computer, for one or more participants in an instructional course, the method comprising steps of:
receiving registration data regarding the one or more participants enrolled in the instructional course;
receiving information relating to one or more action plans for each participant, wherein the one or more action plans include one or more tasks to be implemented, based on practices and lessons presented in the instructional course;
storing the received information relating to the one or more action plans;
sending one or more electronic notifications over a network to the one or more participants for completing one or more surveys before, during, or after the instructional course;
responsive to the one or more electronic notifications, receiving survey responses from the one or more participants before, during, or after the instructional course; and
updating the one or more action plans.

18. The method of claim 17, wherein the step of receiving information relating to the one or more action plans for each participant comprises:
storing the received information relating to the one or more action plans as baseline action plans, wherein the one or more action plans comprise implementation tasks for monitoring progress made on the one or more action plans by each participant;
receiving updates to the implementation tasks from the one or more participants; and
updating the one or more action plans with the received updates.

19. The method of claim 17, wherein the step of sending one or more electronic notifications comprises sending periodically the one or more electronic notifications to each participant based on a status of a survey indicating whether or not to send the one or more electronic notifications to each participant.
